(19) United States
(12) Patent Application Publication
(10) Pub. No.: US 2025/0254434 A1
(43) Pub. Date: Aug. 7, 2025

(54) FLICKER CORRECTION FOR IMAGE FRAMES

(71) Applicant: QUALCOMM Incorporated, San Diego, CA (US)

(72) Inventors: Jianyou Li, San Diego, CA (US); Zuguang Xiao, San Diego, CA (US); Jiafu Luo, Irvine, CA (US); Ho Sang Lee, San Diego, CA (US)

(21) Appl. No.: 18/435,372

(22) Filed: Feb. 7, 2024

(51) Int. Cl. H04N 23/745; H04N 23/71; H04N 23/80

(52) U.S. Cl. CPC H04N 23/745; H04N 23/71; H04N 23/80

(57) ABSTRACT

A device for image processing includes an image sensor configured to capture a first set of image frames; a buffer configured to store information indicative of luminance of each image frame of the first set of image frames; and processing circuitry configured to: retrieve, from the buffer, the information indicative of luminance of each image frame of the first set of image frames; determine a flicker correction parameter based on the luminance across each of the first set of image frames; and generate additional image frames that are for display based on the flicker correction parameter.

### TECHNICAL FIELD

The disclosure relates to image processing including flicker correction for image frames.

### BACKGROUND

Flicker, sometimes referred to as banding, occurs in image frames due to periodicity of a light element. A light element connected to an alternating current source tends to dim and brighten at double the frequency as the frequency of the alternating current source.

Some image sensors use rolling shutter, where the image sensor exposes different portions of the sensor at different times (e.g., row-by-row or column-by-column). The periodic dimming and brightening of the light element results in different amounts of light being available at different times. Accordingly, for a rolling shutter, the amount of light available for capturing content for one row or column of sensors for an image frame can be different than the amount of light available for capturing content for another row or column of sensors for the image frame. The changes in amount of available light during capturing of one image frame results in flickering or banding within that image frame where some rows or columns in the image frame appear darker or lighter than other rows or columns in the same image frame.

### SUMMARY

In general, this disclosure describes techniques for flicker correction, also called banding correction, of image frames. Flicker or banding refers to the luminance (e.g., brightness) of different portions of an image frame being different. In one or more examples described in this disclosure, processing circuitry may be configured to determine a flicker correction parameter based on a first set of image frames, and generate additional image frames for display based on the flicker correction parameter.

A buffer may store information indicative of a luminance of each image frame of the first set of image frames. The processing circuitry may retrieve the information indicative of luminance of each image frame of the first set of image frames. Based on the luminance across each of the first set of image frames, the processing circuitry may determine the flicker correction parameter. That is, rather than determining the flicker correction parameter, the processing circuitry may determine the flicker correction parameter based on information generated from the luminance across the first set of image frames (e.g., changes in the luminance frame-to-frame, etc.). In this way, even before image frames are displayed, such as in a preview mode, flicker can be reduced, resulting in a better overall experience for the viewer.

In one example, the disclosure describes a device for image processing, the device comprising: an image sensor configured to capture a first set of image frames; a buffer configured to store information indicative of luminance of each image frame of the first set of image frames; and processing circuitry configured to: retrieve, from the buffer, the information indicative of luminance of each image frame of the first set of image frames; determine a flicker correction parameter based on the luminance across each of the first set of image frames; and generate additional image frames that are for display based on the flicker correction parameter.

In one example, the disclosure describes a method of image processing, the method comprising: capturing, with an image sensor, a first set of image frames; storing, with a buffer, information indicative of luminance of each image frame of the first set of image frames; retrieving, with a processing circuitry and from the buffer, the information indicative of luminance of each image frame of the first set of image frames; determining, with the processing circuitry, a flicker correction parameter based on the luminance across each of the first set of image frames; and generating, with the processing circuitry, additional image frames that are for display based on the flicker correction parameter.

In one example, the disclosure describes a computer-readable storage medium storing instructions thereon that when executed cause one or more processors to: retrieve, from a buffer, the information indicative of luminance of each image frame of the first set of image frames; determine a flicker correction parameter based on the luminance across each of the first set of image frames; and generate additional image frames that are for display based on the flicker correction parameter.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of a device configured to perform one or more of the example techniques described in this disclosure.

FIG. 2A is a conceptual diagram illustrating changes in amplitude of an alternating current.

FIG. 2B is a conceptual diagram illustrating an example of changes in light intensity corresponding to the changes in amplitude of the alternating current of FIG. 2A.

FIG. 3 is a picture illustrating an example of flicker or banding.

FIG. 4 is a block diagram illustrating an image sensor and camera processor of the computing device of FIG. 1 in further detail.

FIG. 5 is a flowchart illustrating a method of operation according to one or more example techniques described in this disclosure.

### DETAILED DESCRIPTION

An image sensor includes a plurality of sensor elements (e.g., photodiodes) that capture light, convert the light to electrical signals, and generate image frames from the electrical signals. With various filtering techniques, such as including a Bayer filter over the sensor elements, the image frames may be captured as color image frames. A user may take a picture using a camera, where the picture is an example of the image frame.

Some image sensors are configured to generate image frames using a rolling shutter. With a rolling shutter, the image sensor does not capture the image content of the entire image frame simultaneously. Instead, the image sensor exposes and captures the image content using a subset of the sensor elements, e.g., row-by-row or column-by-column. Each row or column of the image content may include one or more rows or columns of the sensor elements. For instance, the image sensor may expose a first band of one or more rows or columns of sensor elements, followed by a second band of one or more rows or columns of sensor elements, and so forth. Therefore, the image content of an image frame is captured at different times with rolling shutter.

The capture of image content of the image frame at different times can lead to flicker or banding, such as where the luminance of the light (i.e., brightness of the light or light intensity) changes during the image capture. For example, the luminance of a lighting element (e.g., fluorescent light or light emitting diode (LED) light) changes periodically based on a period of an alternating current (AC) source used to power the lighting element (e.g., AC from a wall outlet into which the lighting element is connected). As the absolute value of the amplitude of the AC source increases, the luminance of the lighting element increases, and as the absolute value of the amplitude of the AC source decreases, the luminance of the lighting element decreases.

As described, in a rolling shutter capture, different bands of sensor elements are exposed to the light at different times, and the luminance of the light can also vary over time. This can result in different bands of sensor elements being exposed to different luminance of the light, which in turn causes flickering in the image frame such as causing bands in the image frame with different levels of luminance.

This disclosure describes example techniques to address the flickering, including techniques in which the flickering is at least partially compensated before image frames are displayed. As an example, a user may begin a camera session, where a camera session refers to a user interacting with a device to take a picture (e.g., open camera application on a smartphone or turn on a digital camera). Prior to taking a picture, the device is in preview mode, where the user is able to view what the picture will look like when taken.

There may be techniques that correct for flicker after the picture is taken. However, there may be issues with at least partially correcting for flicker in image frames that are displayed as part of preview mode.

This disclosure describes example techniques for determining a flicker correction parameter (e.g., including determining a plurality of flicker correction parameters) so that flicker correction can be applied before any image frames are displayed (e.g., before image frames are displayed in preview mode). Moreover, even where preview mode is not available or where the techniques are not applied to preview mode, by determining the flicker correction parameter, and generating image frames based on the flicker correction parameter, the amount of flicker present for post-image capture flicker correction techniques is reduced. In such cases, the post-image capture flicker correction techniques can be more effective.

In one or more examples, the image sensor includes a buffer (e.g., first-in-first-out buffer) that stores information indicative of a luminance of a first set of image frames. As one example, the buffer stores an average luminance value of a first image frame of the first set of image frames, stores an average luminance value of a second image frame of the first set of image frames, and so forth. In some examples, the memory addresses where the information indicative of the luminance of the respective image frames is stored are contiguous memory addresses.

The processing circuitry (e.g., in some examples with a single read command) may retrieve the information indicative of luminance of each image frame of the first set of image frames. The processing circuitry may determine whether flicker will be present in additional image frames based on the luminance across each of the first set of image frames. As one example, if the average luminance value tends to increase frame-to-frame until reaching a peak, and then tends to decrease frame-to-frame, there is a possibility that flicker will be present in additional image frames captured after the first set of image frames. In one or more examples, the processing circuitry may determine a lighting frequency based on the retrieved information indicative of luminance, where the lighting frequency represents how fast the average luminance value increases and decreases across image frames. The lighting frequency may be based on the frequency of the AC source. That is, the frequency of the AC source sets the lighting frequency.

In this disclosure, “a single read command” may mean that the processing circuitry is configured to retrieve the information indicative of luminance of a plurality of image frames stored in the buffer with that read command. The use of a single read command does not necessarily require, but is possible, reading of all of the information indicative of luminance of every image frame stored in the buffer.

If the processing circuitry determines that flicker will be present, the processing circuitry may determine a flicker correction parameter (e.g., one or more flicker correction parameters). Examples of the flicker correction parameters include an exposure time of the image sensor (e.g., how long each band of rows or columns of sensor elements are exposed) or a gain of the image sensor (e.g., gain applied to the electrical signals from the respective sensor elements). As one example, the processing circuitry may use the determined lighting frequency to determine the flicker correction. parameter.

The processing circuitry may generate additional image frames that are for display based on the flicker correction parameter. For instance, the processing circuitry may set the exposure time and/or gain of the image sensor. The image sensor may capture the additional images based on the flicker correction parameter.

In one or more examples, the first set of image frames used for determining the flicker correction parameter may not necessarily be displayed, but are instead used to determine the flicker correction parameter so that the additional images, which are to be displayed, are generated based on the flicker correction parameter. For instance, for a camera session, there is a boot-up period. During the boot-up period, the device used for capturing image frames initializes the image sensor (e.g., set position of a lens of the image sensor, etc.). This boot-up period may generally last in the order of hundreds of milliseconds (e.g., between 100 ms to 200 ms).

The image sensor may be configured to capture the first set of image frames (e.g., those used for determining the flicker correction parameter) during the boot-up period. As one example, the image sensor may be configured to capture the first set of image frames at a relatively high frame rate, such as 240 frames per second (fps), and a low maximum exposure time (e.g., 4.1 ms). In one or more examples, the image sensor may be configured to capture the first set of image frames a relatively low resolution (e.g., 1 mega-pixel (MP) or 2.1 MP resolution), as compared to the resolution at which the image sensor captures image frames during preview mode (e.g., 12 MP resolution). For the first set of image frames, the image sensor may not apply rolling shutter or may apply rolling shutter, but with a relatively low shutter time.

Processing circuitry, such as that of the image sensor (e.g., on-sensor processing circuitry), may be configured to determine the information indicative of the luminance of each image frame of the first set of image frames. For instance, the processing circuitry may determine a luminance value of each sample (e.g., pixel) in a first image frame of the first set of image frames, and average the luminance values to determine an average luminance value for the first image frame. The processing circuitry may repeat similar operations for the other image frames in the first set of image frames.

The processing circuitry may store the information indicative of the luminance of each of the image frames of the first set of image frames in the contiguous addresses of the buffer. This way, with a single read command (e.g., one that defines the range of addresses), the processing circuitry can retrieve the information indicative of the luminance of each of the image frames, and determine the flicker correction parameter. Again, although possible, the single read command should not be considered as requiring the reading of the information indicative of the luminance of all image frames, but instead refers to the reading of the information indicative of the luminance of the image frames that is within the address range defined by the read command. The address range defined by the read command may be for a plurality of the image frame. The image sensor may be configured to capture the first set of images during a boot-up period of a camera session, and the processing circuitry may be configured to determine the flicker correction parameter before any image frames are displayed for that camera session.

By retrieving information indicative of the luminance of each of the image frame, and using the luminance across each of the first set of image frames (e.g., such changes in luminance, etc.), the example techniques may allow for flicker correction with reduced power consumption. For instance, in some other techniques, it may be possible for the processing circuitry to retrieve information indicative of luminance of an image frame one-by-one, and determine the flicker correction parameter based on each frame one-by-one.

However, such retrieval of the image frame one-by-one can be memory bandwidth extensive and computationally inefficient as the processing circuitry would need to output multiple read commands and quickly process the information indicative of the luminance to determine the flicker correction parameter. Moreover, such retrieval of the image frame one-by-one and determination of the flicker correction parameter for each frame can result in the flicker correction parameter oscillating. For instance, the processing circuitry may determine the flicker correction parameter based on a first image frame, and then update the flicker correction parameter based on a second image frame, and then again update the flicker correction parameter based on a third image frame. If the first and third image frames are captured in high luminance (e.g., high light intensity), and the second image frame is capture in low luminance (e.g., low light intensity), then the flicker correction parameter may oscillate from a first value to a second value after the second image frame, but then oscillate back to the first value after the third image frame.

The example techniques may provide the benefit of flicker correction that is applied before images are displayed in a memory bandwidth and computationally efficient manner. For instance, the processing circuitry may read (e.g., utilize a single read command to read) the information indicative of the luminance of each image frame in the first set of image frames. The processing circuitry may then determine the flicker correction parameter based on the first set of image frames, instead of a per-frame basis. That is, the processing circuitry may determine the flicker correction parameter based on luminance across the first set of image frames, instead on the luminance of one frame (e.g., instead of on a per-frame basis).

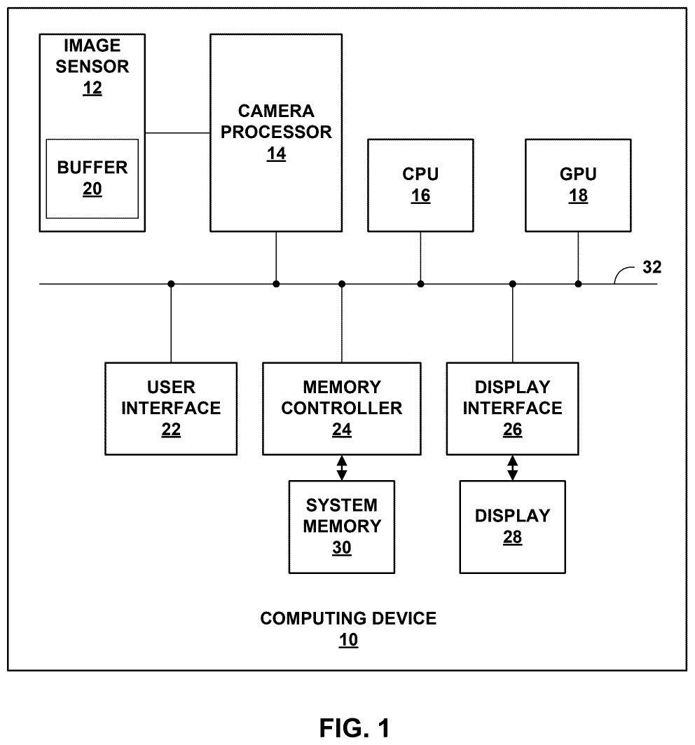

FIG. 1 is a block diagram of a device configured to perform one or more of the example techniques described in this disclosure. Examples of computing device 10 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone for teleconferencing, an Internet telephone, a handheld device such as a portable video game device or a personal digital assistant (PDA). Additional examples of computing device 10 include a personal music player, a video player, a display device, a camera, a television, a set-top box, a broadcast receiver device, a server, an intermediate network device, a mainframe computer or any other type of device that processes and/or displays graphical data.

As illustrated in the example of FIG. 1, computing device 10 includes image sensor 12, a camera processor 14, a central processing unit (CPU) 16, a graphical processing unit (GPU) 18, user interface 22, memory controller 24 that provides access to system memory 30, and display interface 26 that outputs signals that cause graphical data to be displayed on display 28. In FIG. 1, image sensor 12 includes buffer 20. In one or more examples, buffer 20 may be dedicated buffer memory for image sensor 12. That is, buffer 20 may not be available to other components for storage. Buffer 20 need not necessarily be part of image sensor 12. In one or more examples, buffer 20 is a first-in-first-out (FIFO) buffer.

In some examples, buffer 20 may be part of camera processor 14, and may be dedicated memory of camera processor 14. In some examples, buffer 20, when located within camera processor 14, may be dedicated for storing information indicative of luminance in accordance with the techniques described in this disclosure.

Although FIG. 1 illustrates image sensor 12 as part of the same device that includes camera processor 14, CPU 16, and GPU 18, the techniques described in this disclosure are not so limited. In some examples, camera processor 14, CPU 16, and GPU 18 and many of the various other components illustrated in FIG. 1 may be on a different device (e.g., a processing device) than image sensor 12.

Also, although the various components are illustrated as separate components, in some examples the components may be combined to form a system on chip (SoC). As an example, camera processor 14, CPU 16, GPU 18, and display interface 26 may be formed on a common integrated circuit (IC) chip. In some examples, one or more of camera processor 14, CPU 16, GPU 18, and display interface 26 may be in separate IC chips. Various other permutations and combinations are possible, and the techniques should not be considered limited to the example illustrated in FIG. 1. The various components illustrated in FIG. 1 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

The various units illustrated in FIG. 1 communicate with each other using bus 32. Bus 32 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced extensible Interface (AXI) bus) or another type of bus or device interconnect. It should be noted that the specific configuration of buses and communication interfaces between the different components shown in FIG. 1 is merely exemplary, and other configurations of computing devices and/or other image processing systems with the same or different components may be used to implement the techniques of this disclosure.

Camera processor 14 may be external to computing device 10; however, it may be possible for camera processor 14 to be internal to computing device 10, as illustrated. For instance, in some examples, image sensor 12 and camera processor 14 may form a pluggable camera for a desktop or laptop computer, and CPU 16, GPU 18, and the various other components may be part of the desktop or laptop computer. For case of description, the examples are described with respect to the configuration illustrated in FIG. 1.

Image sensor 12 includes a plurality of sensor elements (e.g., photodiodes) arranged in 2×2 grid. The sensor elements may be CMOS (Complementary Metal-Oxide-Semiconductor) sensor elements. Each sensor element generates an electrical signal based on a luminance of the light incident to the sensor element. With filtering, such as Bayer filtering, the electrical signals generated by each of the sensor element indicate the luminance of a particular color.

Camera processor 14 is configured to receive electrical signals as sensor signals from respective sensor elements of image sensor 12 and process the electrical signals to generate pixel data of an image frame. In some examples, camera processor 14 may be configured as a single-input-multiple-data (SIMD) architecture. Camera processor 14 may perform the same operations on electrical signals received from each of the sensor elements of image sensor 12. Each lane of the SIMD architecture may include an image pipeline. The image pipeline includes hardwire circuitry and/or programmable circuitry (e.g., at least one of fixed-function or programmable circuitry) to process the output of the sensors to generate pixel values for pixels.

In one or more examples, processing circuitry of image sensor 12 may include respective trans-impedance amplifiers (TIAs) to convert the electrical signals (e.g., current) to a voltage and respective analog-to-digital converters (ADCs) that convert the analog voltage output into a digital value. The electrical signal outputted by each sensor element indicates the luminance (e.g., light intensity) of a red, green, or blue component. These examples described with respect to processing circuitry of image sensor 12 may be part of camera processor 14, in some examples.

As described in more detail, in one or more examples, the processing circuitry of image sensor 12, camera processor 14, or possibly some other component may be configured to utilize a first set of image frames, which may not be displayed, to determine a flicker correction parameter to address flicker. For additional images that are displayed, camera processor 14 may perform some additional post-processing to increase the quality of the final image. For example, camera processor 14 may evaluate the color and brightness data of neighboring image pixels and perform demosaicing to update the color and brightness of the image pixel. Camera processor 14 may also perform noise reduction and image sharpening, as additional examples. Camera processor 14 outputs the resulting images (e.g., pixel values for each of the image pixels) to system memory 30 via memory controller 24.

CPU 16 may comprise a general-purpose or a special-purpose processor that controls operation of computing device 10. A user may provide input to computing device 10 to cause CPU 16 to execute one or more software applications. The user may provide input to computing device 10 via one or more input devices (not shown) such as a keyboard, a mouse, a microphone, a touch pad or another input device that is coupled to computing device 10 via user interface 22.

One example of the software application is a camera application. CPU 16 executes the camera application, and in response, the camera application causes CPU 16 to generate content that display 28 outputs. For instance, display 28 may output information such as light intensity, whether flash is enabled, and other such information. The user of computing device 10 may interface with display 28 to configure the manner in which the images are generated (e.g., with or without flash, focus settings, exposure settings, and other parameters). The camera application also causes CPU 16 to instruct camera processor 14 to process the images captured by image sensor 12 in the user-defined manner.

As one example, the user interacting with the camera application may be considered as a start of a camera session, and the end of the camera session may be after the user takes the picture or exits the camera application. In examples where device 10 is a digital camera, the start of the camera session may be when the user turns on the digital camera to take a picture or video.

GPU 18 may generate graphical information that provides the user information about the image frames to be captured. For instance, GPU 18 may generate a graphic that indicates whether flash is enabled, generate boxes around identified faces, etc.

Memory controller 24 facilitates the transfer of data going into and out of system memory 30. For example, memory controller 24 may receive memory read and write commands, and service such commands with respect to memory 30 in order to provide memory services for the components in computing device 10. Memory controller 24 is communicatively coupled to system memory 30. Although memory controller 24 is illustrated in the example of computing device 10 of FIG. 1 as being a processing circuit that is separate from both CPU 16 and system memory 30, in other examples, some or all of the functionality of memory controller 24 may be implemented on one or both of CPU 16 and system memory 30.

System memory 30 may store program modules and/or instructions and/or data that are accessible by camera processor 14, CPU 16, and GPU 18. For example, system memory 30 may store user applications (e.g., instructions for the camera application), resulting images from camera processor 14, etc. System memory 30 may additionally store information for use by and/or generated by other components of computing device 10. For example, system memory 30 may act as a device memory for camera processor 14. System memory 30 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 30 may include instructions that cause camera processor 14, CPU 16, GPU 18, and display interface 26 to perform the functions ascribed to these components in this disclosure. Accordingly, system memory 30 may be a computer-readable storage medium having instructions stored thereon that, when executed, cause one or more processors (e.g., camera processor 14, CPU 16, GPU 18, and display interface 26) to perform various functions.

In some examples, system memory 30 is a non-transitory storage medium. The term “non-transitory” indicates that the storage medium is not embodied in a carrier wave or a propagated signal. However, the term “non-transitory” should not be interpreted to mean that system memory 30 is non-movable or that its contents are static. As one example, system memory 30 may be removed from computing device 10, and moved to another device. As another example, memory, substantially similar to system memory 30, may be inserted into computing device 10. In certain examples, a non-transitory storage medium may store data that can, over time, change (e.g., in RAM).

Camera processor 14, CPU 16, and GPU 18 may store image data, and the like in respective buffers that are allocated within system memory 30. Display interface 26 may retrieve the data from system memory 30 and configure display 28 to display the image represented by the generated image data. In some examples, display interface 26 may include a digital-to-analog converter (DAC) that is configured to convert the digital values retrieved from system memory 30 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, or another type of display unit. Display 28 may be integrated within computing device 10. For instance, display 28 may be a screen of a mobile telephone handset or a tablet computer. Alternatively, display 28 may be a stand-alone device coupled to computing device 10 via a wired or wireless communications link. For instance, display 28 may be a computer monitor or flat panel display connected to a personal computer via a cable or wireless link.

In one or more examples, image sensor 12 may be configured to capture image frames using a rolling shutter. Unlike a global shutter, which captures the entire image frame at once, a rolling shutter exposes different parts of image sensor 12 at different times. As described above, in rolling shutter, image sensor 12 exposes and captures the image content row-by-row or column-by-column. Each row or column of the image content may include one or more rows or columns of the sensor elements. For instance, image sensor 12 may expose a first band of one or more rows or columns of sensor elements, followed by a second band of one or more rows or columns of sensor elements, and so forth.

The exposure process typically starts at one edge of image sensor 12 (e.g., the first band of one or more rows or columns is along a top edge or left edge of image sensor 12) and progresses to the other edge. As each band of one or more rows or columns of the sensor elements is exposed, image sensor 12 reads the light information and resets for the next exposure. This process may occur within fractions of a second.

Because the exposure is not instantaneous for the entire image frame, there is a time offset between the capture of the first and last band of one or more rows or columns of the sensor elements. This time offset may create a rolling shutter effect, which can manifest as flicker or banding.

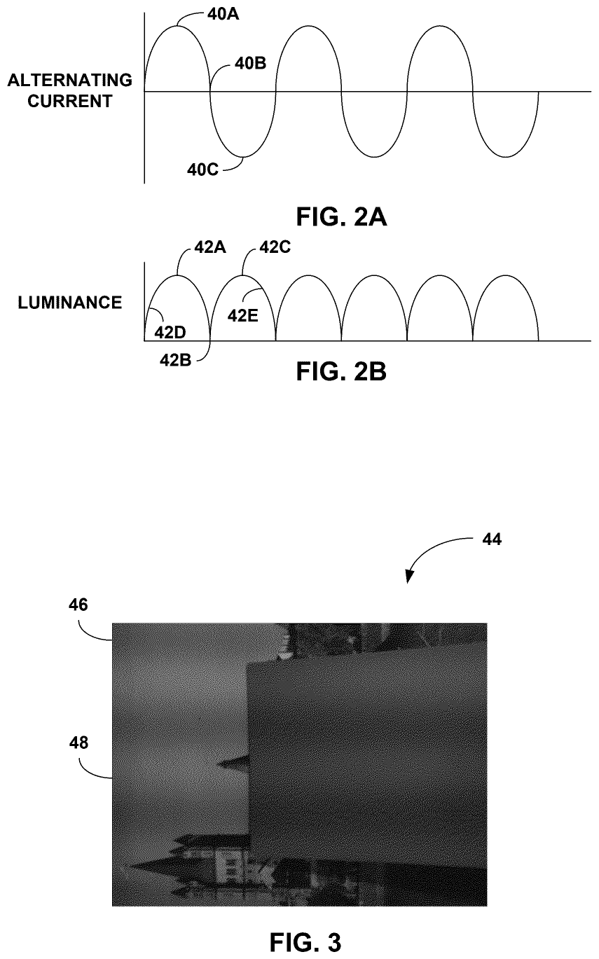

For example, because a band of sensor elements is exposed at different times, the amount of light captured by one band of sensor elements can be different than the amount of light captured by another band of sensor elements. For example, the light that image sensor 12 captures can be from an artificial light source such as a fluorescent light bulb or LEDs. The luminance of the light source may be a factor of an alternating current (AC) source that powers the light source. Since the amplitude of the AC source is periodic, the luminance of the light source can also be periodic (e.g., increasing to a peak, then decreasing, and then increasing again). This is further illustrated with respect to FIGS. 2A, 2B, and 3.

FIG. 2A is a conceptual diagram illustrating changes in amplitude of an alternating current from an AC source. The AC source may be an electrical power line. As illustrated in FIG. 2A, the amplitude of alternating current increases to a positive peak 40A, then decreases cross through a zero amplitude 40B, and decreases to a negative peak 40C, and repeats. The frequency of the alternating current may be 50 Hz or 60 Hz.

FIG. 2B is a conceptual diagram illustrating an example of changes in light intensity corresponding to the changes in amplitude of the alternating current of FIG. 2A. For instance, as the absolute value of the amplitude of alternating current increases the luminance (e.g., light intensity or brightness) increases until reaching a luminance peak 42A which corresponds in time to peak 40A or FIG. 2A, then the luminance decreases to zero luminance 42B, which corresponds in time to zero amplitude 40B of FIG. 2A. The luminance then increases, as the absolute value of the amplitude of the alternating increases, until reaching a luminance peak 42C, which corresponds into time to peak 40C of FIG. 2A.

If the frequency of the alternating current of the AC source is 50 Hz, the period of lighting (e.g., time from peak 42A to peak 42C) is 10 milliseconds, which would correspond to the time from peak 40A to peak 40C in FIG. 2A for a 50 Hz alternating current. If the frequency of the alternating current of the AC source is 60 Hz, the period of lighting (e.g., time from peak 42A to peak 42C) is 8.33 milliseconds, which would correspond to the time from peak 40A to peak 40C in FIG. 2A for a 60 Hz alternating current.

As illustrated in FIG. 2B, since the luminance of the lighting source changes over time, the amount of light that a band of sensor elements of image sensor 12 captures can change band-to-band. For instance, if the exposure time of rolling shutter image sensor is not a multiple of the lighting periodic time, the image frame has periodic brightness variation from top to bottom or left to right, which is referred to as flicker or banding.

FIG. 3 is a picture illustrating an example of flicker or banding. FIG. 3 illustrates picture 44. In picture 44, assume that the sensor elements of image sensor 12 that correspond to band 46 of picture 44 were exposed when the luminance of the lighting source was at luminance level 42D of FIG. 2B, and assume that the sensor elements of image sensor 12 that correspond to band 48 of picture 44 were exposed when the luminance of the lighting source was at luminance level 42E. In this example, because luminance level 42D is less than luminance level 42E, band 46 of picture 44 is darker (e.g., less luminance) than band 48. Such flicker or banding can negatively affect image quality.

In some techniques, camera processor 14 may determine that there is flicker in the image frames that are being displayed. Once determined that there is flicker in the image frames, camera processor 14, or possibly some other component, may turn on flicker correction. However, the flicker correction does not turn on until the user has viewed at least some image frames with flicker, which the user may find to be undesirable.

In one or more examples, image sensor 12 may be configured to capture a first set of image frames. For the first set of image frames, image sensor 12 may not utilize rolling shutter, but it is possible for image sensor 12 to capture the first set of image frames using rolling shutter. In some examples, image sensor 12 may capture the first set of image frames in at a first capture rate, such as 240 fps. Image sensor 12 may capture the first set of image frames at a first resolution, such as 1 or 2 mega-pixel resolution of HD or FHD. For instance, image sensor 12 may capture the first set of images during a boot-up period of a camera session. Since the boot-up period is relatively short, to capture sufficient image frames, the capture rate may be relatively high and the resolution may be relatively low.

Processing circuitry (e.g., circuitry of image sensor 12 or camera processor 14) may be configured to determine information indicative of luminance of each image frame in the first set of image frames. For example, the processing circuitry may average the luminance of each sample of an image frame to generate the information indicative of the luminance of that frame. There may be other examples of the information indicative of the luminance of that frame, such as the mode or median luminance value, or the largest or smallest luminance value. In some examples, the information indicative of the luminance of that frame may be based on luminance of particular pre-selected samples (e.g., samples in the middle of the frame).

The processing circuitry may store the information indicative of luminance of each image frame of the first set of image frames in buffer 20. For instance, the processing circuitry may store the information indicative of the luminance of a first image frame at a first location identified by a first address in buffer 20, store the information indicative of the luminance of a second image frame at a second location identified by a second address in buffer 20, and so forth. The first address, second address, and additional addresses may be contiguous addresses.

Camera processor 14 or circuitry of image sensor 12 may be configured to retrieve the information indicative of luminance of each image frame of the first set of image frames from buffer 20. In one or more examples, camera processor 14 or circuitry of image sensor 12 may retrieve the information with a single read command. For example, camera processor 14 may output a read command that defines a range of addresses within buffer 20, and retrieve the information stored in locations identified by each address within the range of addresses. Camera processor 14 or circuitry of image sensor 12 retrieving the information with a single read command is not necessary in all examples.

Based on the information indicative of the luminance across the image frames, camera processor 14 or circuitry of image sensor 12 may determine whether flicker would be present in additional image frames captured by image sensor 12, such as for preview mode. That is, in some examples, the first set of image frames may not be for display, but instead used for flicker correction. For instance, because the first set of image frames may be captured during a boot-up period, it may be possible to determine flicker correction before any image frames are streamed for display, such as streamed for display in preview mode before the user takes the picture.

In one or more examples, camera processor 14 or circuitry of image sensor 12 may determine whether flicker would be present based on changes to luminance across a plurality of image frames. For instance, rather than evaluating the luminance of one image frame, and determining whether flicker would be present and what the flicker correction parameter(s) should be, camera processor 14 or circuitry of image sensor 12 may evaluate luminance across image frames (e.g., such as changes in luminance between image frames, and not just on a per-frame basis).

Preview mode is one example, and not limiting. For instance, camera processor 14 may determine whether flicker would be present in an additional image that the user takes (e.g., uses device 10 to take a picture that is stored in ROM). The image frames captured as part of preview mode may be temporarily stored and displayed for user viewing. The image frames captured as part of preview mode are written over in memory relatively quickly. When the user takes an actual picture, the image frame for that picture is stored for a longer duration, including after device 10 is turned off. Preview mode is generally the mode in which the user can view the image content before the actual picture is taken. Stated another way, in preview mode, device 10 is capturing images continuously, but the images are not permanently stored. In “taking a picture,” device 10 may mark a particular picture or set of pictures for storage. Some other post processing may also occur.

As an example, camera processor 14 or circuitry of image sensor 12 may determine a lighting frequency based on the retrieved information (e.g., luminance across image frames, such as changes in luminance across image frames). For instance, if there is periodicity in the luminance across the first set of images, camera processor 14 or circuitry of image sensor 12 may determine that there will likely be flicker in the additional image frames captured for display (e.g., in preview mode or when the user takes a picture).

In one or more examples, camera processor 14 or circuitry of image sensor 12 may determine a flicker correction parameter based on the retrieved information. For example, camera processor 14 or circuitry of image sensor 12 may determine an exposure time of image sensor 12 and a gain of image sensor 12. The exposure time may refer to the amount of time a band of the sensor elements of image sensor 12 are exposed, and the gain of image sensor 12 may refer to the gain applied to the electrical signal generated by the sensor elements of image sensor 12.

In this way, image sensor 12 is configured to capture the first set of images during a boot-up period of a camera session. Also, camera processor 14 or circuitry of image sensor 12 is configured to determine the flicker correction parameter before any image frames are displayed for that camera session.

Camera processor 14 or circuitry of image sensor 12 may then generate additional image frames for display based on the flicker correction parameter. For example, camera processor 14 or circuitry of image sensor 12 may set the exposure time or the gain of image sensor 12 to generate the additional image frames for display. Image sensor 12 may capture the additional image frames (e.g., utilizing rolling shutter). As described above, image sensor 12 may capture the first set of image frames at a first capture rate, which is relatively high, and possibly at a first resolution, which is relatively low. Image sensor 12 may capture the additional image frames at a second capture rate (e.g., 30 fps or 60 fps), and may capture the additional image frames a second resolution (e.g., 12 MP). The first capture rate may be greater than the second capture rate, and the first resolution may be less than the second resolution.

In some examples, the flicker correction parameter that camera processor 14 or the circuitry of image sensor 12 determines may be an initial flicker correction parameter. Camera processor 14 or the circuitry of image sensor 12 may be configured to update the flicker correction parameter based on the additional image frames that are displayed as part of preview mode or other images. Accordingly, even though the flicker correction parameter may be further updated, the flicker correction parameter that camera processor 14 or the circuitry of image sensor 12 determines from the first set of image frames may be a relatively accurate approximation of the flicker correction parameter. This way, the additional image frames that are displayed with preview mode tend to have reduced flicker or banding, and any additional flicker correction that is applied can be more effective because there is already a reduction in the flicker from applying the initial flicker correction parameter determined from the first set of images captured during the boot-up period.

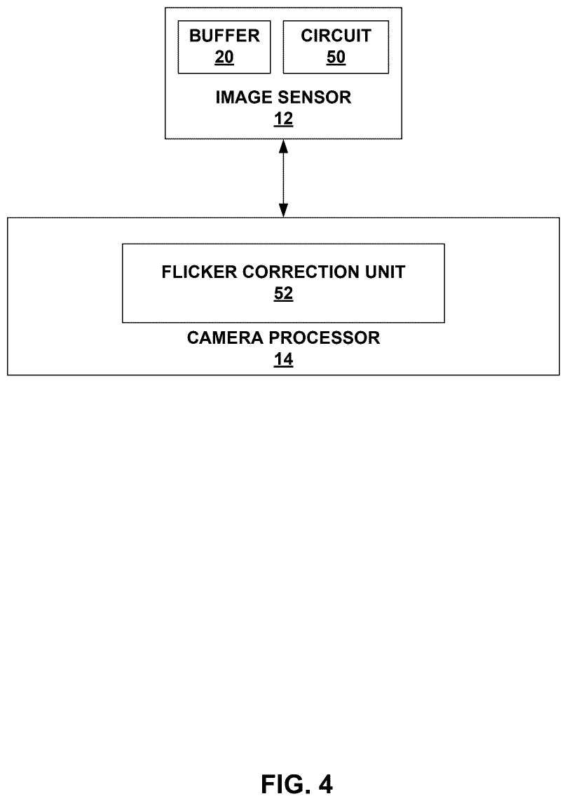

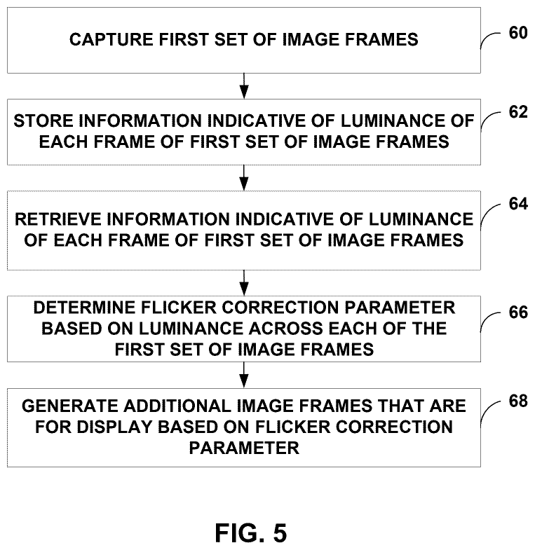

FIG. 4 is a block diagram illustrating an image sensor and camera processor of the computing device of FIG. 1 in further detail. FIG. 5 is a flowchart illustrating a method of operation according to one or more example techniques described in this disclosure. For ease of description, the example of FIG. 4 and FIG. 5 are described together.

As illustrated in FIG. 4, image sensor 12 includes buffer 20 and circuit 50. Camera processor 14 includes flicker correction unit 52. Flicker correction unit 52 may be fixed-function or programmable circuitry configured to perform one or more example techniques described in this disclosure. In this disclosure, the term “processing circuitry” may refer to circuit 50, flicker correction unit 52, or a combination of flicker correction unit 52 and circuit 50. That is, the processing circuitry may be encompass some or all of the circuitry for perform the example techniques described in this disclosure even if such circuitry is distributed across different components.

In one or more examples, image sensor 12 may capture a first of image frames (60 of FIG. 5). Image sensor 12 may be configured to capture the first set of images during a boot-up period of a camera session, and may be configured to capture the first set of images at a first capture rate (e.g., 240 fps) with low exposure time (e.g., 4.1 ms). Image sensor 12 may be configured to capture the first set of images at a first resolution (e.g., 1 MP or 2 MP).

Circuit 50 may be configured to determine information indicative of luminance of each image frame of the first set of image frames. For example, circuit 50 may determine an average luminance value of each image frame. Circuit 50 may store, in buffer 20, the information indicative of luminance of each image frame of the first set of image frames (62 of FIG. 5). Buffer 20 may be a dedicated buffer of image sensor 12, and may be integrated within image sensor 12.

Flicker correction unit 52 may retrieve (e.g., with a single read command to buffer 20), the information indicative of luminance of each image frame (64 of FIG. 5). In this way, flicker correction unit 52 may retrieve the information indicative of luminance in a burst-read, rather than repeatedly polling image sensor 12, which can increase I2C communication time and increase complexity.

In one or more examples, flicker correction unit 52 may determine whether there will be flicker in additional image frames. For instance, flicker correction unit 52 may determine a lighting frequency based on the retrieved information (e.g., a periodicity at which the luminance increases and then decreases). If there is periodicity in the luminance across the image frames of the first set of image frames, flicker correction unit 52 may determine that there will be flicker in additional image frames that are displayed. That is, flicker correction unit 52 may determine a lighting frequency based on luminance across the image frames of the first set of image frames.

Flicker correction unit 52 may determine a flicker correction parameter based on the luminance across each of the first set of image frames (66 of FIG. 5) (e.g., based on the retrieved information). In one or more examples, flicker correction unit 52 may determine the flicker correction parameter before any image frames are displayed for that camera session.

Examples of the flicker correction parameter include one or more of an exposure time of image sensor 12 and a gain of image sensor 12. As one example, flicker correction unit 52 may determine the flicker correction parameter based on the lighting frequency. For instance, flicker correction unit 52 may determine the exposure time to synchronize with the lighting frequency. As an example, if the period of the lighting frequency is 10 ms, then flicker correction unit 52 may determine the exposure time to be 10 ms. This way, each band of sensor elements captures image content at approximately the same luminance of the lighting source. The synchronization ensures that the exposure of each band of sensor elements aligns with a peak or trough of the lighting, reducing the chances of capturing variations in luminance.

Similarly, flicker correction unit 52 may determine the gain of the sensor elements. For instance, when the light intensity is at a minimum, as can be determined from the lighting frequency, flicker correction unit 52 may set a relatively high gain for sensor elements that will be exposed. When the light intensity is at a maximum, as can be determined from the lighting frequency, flicker correction unit 52 may set a relatively low gain for sensor elements that will be exposed.

Accordingly, in one or more examples, flicker correction unit 52 may determine the flicker correction parameter(s) based on luminance across each of the first set of image frames. That is, flicker correction unit 52 may not determine the flicker correction parameter(s) on a per-frame basis, but based on how the luminance is changing across the first set of image frames. That is, flicker correction unit 52 may utilize luminance of a plurality of image frames to determine the flicker correction parameter, instead of updating the flicker correction parameter on a per-frame basis.

Flicker correction unit 52 may generate additional image frames that are for display based on the flicker correction parameter (68 of FIG. 5). For example, flicker correction unit 52 may set the exposure time and/or gain of image sensor 12. Image sensor 12 may be configured to capture the additional image frames utilizing a rolling shutter, and may capture the additional image frames at a second capture rate (e.g., 30 fps or 60 fps).

In one or more examples, camera processor 14 may be configured to output the additional image frames for display as part of a preview mode. Because the additional image frames are generated based on the flicker correction parameter, there may be a reduction in the flicker in the additional image frames. Moreover, flicker correction unit 52 may be configured to update the flicker correction parameter based on the additional image frames that are displayed (e.g., as part of the preview mode). For instance, the flicker correction parameter determined from the first set of image frames may be considered as an initial flicker correction parameter. As image sensor 12 captures additional image frames, flicker correction unit 52 may update the flicker correction parameter.

In one or more examples, in addition to the techniques described of applying flicker correction based on the flicker correction parameter determined from the first set of image frames, flicker correction unit 52 may be configured to apply post-processing (e.g., after a picture is taken) to further correct flicker. For instance, after a picture is taken, but before the picture is displayed, flicker correction unit 52 may smooth out any flicker in the picture. However, because the flicker correction parameter was determined before the picture is taken, the amount of flicker in the picture is reduced, and the post-processing flicker correction is more effective as there is less flicker to correct.

The following describes one or more examples in accordance with the techniques described in this disclosure.

Clause 1. A device for image processing, the device comprising: an image sensor configured to capture a first set of image frames; a buffer configured to store information indicative of luminance of each image frame of the first set of image frames; and processing circuitry configured to: retrieve, from the buffer, the information indicative of luminance of each image frame of the first set of image frames; determine a flicker correction parameter based on the luminance across each of the first set of image frames; and generate additional image frames that are for display based on the flicker correction parameter.

Clause 2. The device of clauses 1, wherein to retrieve the information, the processing circuitry is configured to retrieve, with a single read command to the buffer, the information indicative of luminance of each image frame of the first set of image frames.

Clause 3. The device of any of clauses 1 or 2, wherein the image sensor is configured to capture the additional image frames utilizing a rolling shutter.

Clause 4. The device of any of clauses 1-3, wherein the information indicative of luminance of each image frame of the first set of image frames comprises information indicative of an average luminance of each image frame of the first set of image frames.

Clause 5. The device of any of clauses 1-4, wherein the buffer is a dedicated buffer of the image sensor.

Clause 6. The device of any of clauses 1-5, wherein the image sensor is configured to capture the first set of images during a boot-up period of a camera session, and the processing circuitry is configured to determine the flicker correction parameter before any image frames are displayed for that camera session.

Clause 7. The device of any of clauses 1-6, wherein the image sensor is configured to capture the first set of image frames at a first capture rate, and capture the additional image frames at a second capture rate, wherein the first capture rate is greater than the second capture rate.

Clause 8. The device of clause 7, wherein the first capture rate is at least 240 frames per second.

Clause 9. The device of any of clauses 1-8, wherein the image sensor is configured to capture the first set of image frames at a first resolution, and capture the additional image frames at a second resolution, wherein the first resolution is less than the second resolution.

Clause 10. The device of any of clauses 1-9, wherein the processing circuitry is configured to output the additional image frames for display as part of a preview mode.

Clause 11. The device of clause 10, wherein the processing circuitry is configured to update the flicker correction parameter based on the additional image frames that are displayed as part of the preview mode.

Clause 12. The device of any of clauses 1-11, wherein the processing circuitry is configured to determine a lighting frequency based on the luminance across each of the first set of image frames, and wherein to determine the flicker correction parameter, the processing circuitry is configured to determine the flicker correction parameter based on the lighting frequency.

Clause 13. The device of any of clauses 1-12, wherein to determine the flicker correction parameter, the processing circuitry is configured to determine an exposure time of the image sensor.

Clause 14. A method of image processing, the method comprising: capturing, with an image sensor, a first set of image frames; storing, with a buffer, information indicative of luminance of each image frame of the first set of image frames; retrieving, with a processing circuitry and from the buffer, the information indicative of luminance of each image frame of the first set of image frames; determining, with the processing circuitry, a flicker correction parameter based on the luminance across each of the first set of image frames; and generating, with the processing circuitry, additional image frames that are for display based on the flicker correction parameter.

Clause 15. The method of clause 14, wherein retrieving the information comprises retrieving, with a single read command to the buffer, the information indicative of luminance of each image frame of the first set of image frames.

Clause 16. The method of any of clauses 14 or 15, further comprising capturing the additional image frames utilizing a rolling shutter.

Clause 17. The method of any of clauses 14-16, wherein the information indicative of luminance of each image frame of the first set of image frames comprises information indicative of an average luminance of each image frame of the first set of image frames.

Clause 18. The method of any of clauses 14-17, wherein capturing the first set of image frames comprises capturing the first set of image frames during a boot-up period of a camera session, and wherein determining the flicker correction parameter comprises determining the flicker correction parameter before any image frames are displayed for that camera session.

Clause 19. The method of any of clauses 14-18, wherein capturing the first set of images comprises capturing the first set of image frames at a first capture rate and at a first resolution, the method further comprising capturing the additional image frames at a second capture rate and a second resolution, wherein the first capture rate is greater than the second capture rate and the first resolution is less than the second resolution.

Clause 20. A computer-readable storage medium storing instructions thereon that when executed cause one or more processors to: retrieve, from a buffer, information indicative of luminance of each image frame of a first set of image frames; determine a flicker correction parameter based on the luminance across each of the first set of image frames; and generate additional image frames that are for display based on the flicker correction parameter.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for image processing, the device comprising:
an image sensor configured to capture a first set of image frames;
a buffer configured to store information indicative of luminance of each image frame of the first set of image frames; and
processing circuitry configured to:
retrieve, from the buffer, the information indicative of luminance of each image frame of the first set of image frames;
determine a flicker correction parameter based on the luminance across each of the first set of image frames; and
generate additional image frames that are for display based on the flicker correction parameter.

2. The device of claim 1, wherein to retrieve the information, the processing circuitry is configured to retrieve, with a single read command to the buffer, the information indicative of luminance of each image frame of the first set of image frames.

3. The device of claim 1, wherein the image sensor is configured to capture the additional image frames utilizing a rolling shutter.

4. The device of claim 1, wherein the information indicative of luminance of each image frame of the first set of image frames comprises information indicative of an average luminance of each image frame of the first set of image frames.

5. The device of claim 1, wherein the buffer is a dedicated buffer of the image sensor.

6. The device of claim 1, wherein the image sensor is configured to capture the first set of images during a boot-up period of a camera session, and the processing circuitry is configured to determine the flicker correction parameter before any image frames are displayed for that camera session.

7. The device of claim 1, wherein the image sensor is configured to capture the first set of image frames at a first capture rate, and capture the additional image frames at a second capture rate, wherein the first capture rate is greater than the second capture rate.

8. The device of claim 7, wherein the first capture rate is at least 240 frames per second.

9. The device of claim 1, wherein the image sensor is configured to capture the first set of image frames at a first resolution, and capture the additional image frames at a second resolution, wherein the first resolution is less than the second resolution.

10. The device of claim 1, wherein the processing circuitry is configured to output the additional image frames for display as part of a preview mode.

11. The device of claim 10, wherein the processing circuitry is configured to update the flicker correction parameter based on the additional image frames that are displayed as part of the preview mode.

12. The device of claim 1, wherein the processing circuitry is configured to determine a lighting frequency based on the luminance across each of the first set of image frames, and wherein to determine the flicker correction parameter, the processing circuitry is configured to determine the flicker correction parameter based on the lighting frequency.

13. The device of claim 1, wherein to determine the flicker correction parameter, the processing circuitry is configured to determine an exposure time of the image sensor.

14. A method of image processing, the method comprising:
capturing, with an image sensor, a first set of image frames;
storing, with a buffer, information indicative of luminance of each image frame of the first set of image frames;
retrieving, with a processing circuitry and from the buffer, the information indicative of luminance of each image frame of the first set of image frames;
determining, with the processing circuitry, a flicker correction parameter based on the luminance across each of the first set of image frames; and
generating, with the processing circuitry, additional image frames that are for display based on the flicker correction parameter.

15. The method of claim 14, wherein retrieving the information comprises retrieving, with a single read command to the buffer, the information indicative of luminance of each image frame of the first set of image frames.

16. The method of claim 14, further comprising capturing the additional image frames utilizing a rolling shutter.

17. The method of claim 14, wherein the information indicative of luminance of each image frame of the first set of image frames comprises information indicative of an average luminance of each image frame of the first set of image frames.

18. The method of claim 14, wherein capturing the first set of image frames comprises capturing the first set of image frames during a boot-up period of a camera session, and wherein determining the flicker correction parameter comprises determining the flicker correction parameter before any image frames are displayed for that camera session.

19. The method of claim 14, wherein capturing the first set of images comprises capturing the first set of image frames at a first capture rate and at a first resolution, the method further comprising capturing the additional image frames at a second capture rate and a second resolution, wherein the first capture rate is greater than the second capture rate and the first resolution is less than the second resolution.

20. A computer-readable storage medium storing instructions thereon that when executed cause one or more processors to:
retrieve, from a buffer, information indicative of luminance of each image frame of a first set of image frames;
determine a flicker correction parameter based on the luminance across each of the first set of image frames; and
generate additional image frames that are for display based on the flicker correction parameter.
